(19) United States
(12) Patent Application Publication
(10) Pub. No.: US 2014/0079949 A1
(43) Pub. Date: Mar. 20, 2014

(54) PRESSURE-SENSITIVE ADHESIVE FILM

(71) Applicants: Ikkou Hanaki, Ibaraki-shi (JP); Natsuki Ukei, Ibaraki-shi (JP)

(72) Inventors: Ikkou Hanaki, Ibaraki-shi (JP); Natsuki Ukei, Ibaraki-shi (JP)

(73) Assignee: NITTO DENKO CORPORATION, Ibaraki-shi, Osaka (JP)

(21) Appl. No.: 14/119,315

(22) PCT Filed: May 11, 2012
(86) PCT No.: PCT/JP2012/062197

§ 371 Date: Nov. 21, 2013

(30) Foreign Application Priority Data
May 23, 2011 (JP) 2011-114808

(51) Int. Cl. C09J 7/02

(52) U.S. Cl. CPC C09J 7/0217
USPC 428/355 AC

(57) ABSTRACT

A pressure-sensitive adhesive film including a substrate and a pressure-sensitive adhesive layer provided on at least one side of the substrate, wherein the pressure-sensitive adhesive layer contains a (meth)acryl-based polymer, an ionic liquid, and a crosslinking agent, and the pressure-sensitive adhesive layer contains 2 parts by weight or less of the crosslinking agent based on 100 parts by weight of the (meth)acryl-based polymer, the pressure-sensitive adhesive film having an adhesive strength of 0.5 N/25 mm or more as measured at a tension rate of 1.0 m/minute after it is placed on an adherend of an acrylic panel under the conditions of 23° C. and 50% RH for 30 minutes.

### TECHNICAL FIELD

The invention relates to a pressure-sensitive adhesive film. The pressure-sensitive adhesive film of the invention is used for plastic products and other products which can easily generate static electricity. In particular, the invention relates to a pressure-sensitive adhesive film that has good adhesive properties (adhesion) to an adherend such as a polarizing plate, a wavelength plate, a retardation plate, an optical compensation film, a reflective sheet, a brightness enhancement film, a diffusion sheet having unevenness on its surface (having a non-smooth surface), or other sheets for use in liquid crystal displays or other applications, is prevented from generating a peeling electrification voltage at the time of peeling off, and has good removability.

### BACKGROUND ART

In general, a surface protective film is bonded to an object to be protected (adherend) with a pressure-sensitive adhesive layer interposed therebetween so that the object can be prevented from being scratched or soiled during the processing or conveyance of the object. For example, a surface protective film is used on an optical member such as a diffusion sheet. After bonded to an optical member, such a surface protective film is used to protect the adherend during delivery or to prevent the adherend from being scratched or soiled during the processing or conveyance of the adherend. After playing a series of roles, such a surface protective film becomes no longer needed and is finally peeled off and removed.

A substrate, a pressure-sensitive adhesive, and a separator constituting a surface protective film are often made of plastic materials. Thus, such a surface protective film has high electric insulation and can generate static electricity through friction or peeling off of the film. The static electricity generated through the peeling off can cause dust or dirt to be deposited on the surface protective film, which can pollute a diffusion sheet or other optical members, can cause a defect such as contamination in the process of bonding it, or can damage a liquid crystal or an electronic circuit sealed inside the adherend.

Thus, to prevent the problem, various antistatic treatments are performed on a surface protective film.

To suppress such static electrification, there has been proposed a method including adding a low-molecular-weight surfactant to a pressure-sensitive adhesive and transferring the surfactant from the pressure-sensitive adhesive to an object to be protected (adherend) (see, for example, Patent Document 1). In such a method, however, the added low-molecular-weight surfactant can easily bleed to the surface of the pressure-sensitive adhesive, and thus staining on the object may occur if the method is applied to a surface protective film. Thus, if a pressure-sensitive adhesive containing a low-molecular-weight surfactant is used to form a surface protective film for use on an optical member such as a diffusion sheet, the problem of a loss of optical properties can occur.

A surface protective film also has the following problem. When an object to be protected has unevenness on its surface (or has a non-smooth surface), such as a diffusion sheet, a surface protective film peel off from the object during delivery or transportation after bonded to the object. Thus, a surface protective film is required to have a high adhesive strength (strong adhesive strength).

As mentioned above, there are no conventional techniques that can solve the problems in a well-balanced way. In a technical field where antistatic properties, adhesive properties, and removability are important, it has been a problem to meet requirements for further improving a surface protective film.

### PRIOR ART DOCUMENT

### Patent Document

Patent Document 1: JP-A-09-165460

### SUMMARY OF THE INVENTION

### Problems to be Solved by the Invention

It is therefore an object of the invention to solve the problems with an adhesive (surface protecting) film used to protect the surface of an adherend having unevenness on its surface (having a non-smooth surface), such as a conventional diffusion sheet, and to provide a pressure-sensitive adhesive film that exhibits good adhesive properties (sufficient adhesion) when bonded to a diffusion sheet or the like, is prevented from generating a peeling electrification voltage when peeled off from an diffusion sheet or the like, and has good removability.

### Means for Solving the Problems

To achieve the object, the inventors have made earnest study on pressure-sensitive adhesive films, and as a result, the inventors have accomplished the invention based on findings that a pressure-sensitive adhesive film having a pressure-sensitive adhesive layer containing a (meth)acryl-based polymer, an ionic liquid, and a crosslinking agent and possessing an adhesive strength in a specific range under given conditions is useful to provide a pressure-sensitive adhesive film that exhibits sufficient adhesion (adhesive properties) to an adherend having unevenness, is prevented from generating static charges during peel off, and has good removability.

Specifically, the invention is directed to a pressure-sensitive adhesive film including a substrate and a pressure-sensitive adhesive layer provided on at least one side of the substrate, wherein the pressure-sensitive adhesive layer contains a (meth)acryl-based polymer, an ionic liquid, and a crosslinking agent, and the pressure-sensitive adhesive layer contains 2 parts by weight or less of the crosslinking agent based on 100 parts by weight of the (meth)acryl-based polymer, the pressure-sensitive adhesive film having an adhesive strength of 0.5 N/25 mm or more as measured at a tension rate of 1.0 m/minute after it is placed on an adherend of an acrylic panel under the conditions of 23° C. and 50% RH for 30 minutes.

The pressure-sensitive adhesive film of the invention preferably has an absolute value of peeling electrification voltage of 0.5 kV or less as measured under the conditions of 23° C. and 50% RH after it is peeled off from an adherend of an acrylic panel at a peeling rate of 10 m/minute.

In the pressure-sensitive adhesive film of the invention, the (meth)acryl-based polymer preferably has a (meth)acryl-based monomer having an alkyl group of 1 to 14 carbon atoms.

In the pressure-sensitive adhesive film of the invention, the ionic liquid is preferably contained in an amount of 0.01 to 2.5 parts by weight based on 100 parts by weight of the (meth)acryl-based polymer.

The pressure-sensitive adhesive film of the invention is preferably for use in protecting the surface of a diffusion sheet.

As used herein, the term “(meth)acryl-based polymer” refers to an acryl-based polymer and/or a methacryl-based polymer, the term “(meth)acryl-based monomer” refers to an acryl-based monomer and/or a methacryl-based monomer, and the term “(meth)acrylate” refers to acrylate and/or methacrylate.

### Effect of the Invention

The pressure-sensitive adhesive film (or surface protective film) of the invention has good adhesive properties until it is peeled off from an adherend. In addition, the pressure-sensitive adhesive film of the invention is useful in that it has a high level of antistatic properties and removability when it is peeled off from an adherend. In particular, the pressure-sensitive adhesive film of the invention is very useful in a technical field related to electronic equipment because it exhibits good adhesive properties to an adherend having unevenness on its surface, such as a diffusion sheet, to which conventional pressure-sensitive adhesive films cannot have sufficient adhesive properties, and because it also has a high level of antistatic properties and removability.

### MODE FOR CARRYING OUT THE INVENTION

Hereinafter, embodiments of the invention will be described in detail.

[(Meth)Acryl-Based Polymer]

In the invention, the pressure-sensitive adhesive layer contains a (meth)acryl-based polymer. The (meth)acryl-based polymer preferably contains a (meth)acryl-based monomer having an alkyl group of 1 to 14 carbon atoms. The use of the (meth)acryl-based polymer is preferred in view of easy handleability, adhesive strength, and peeling property.

In the invention, a (meth)acryl-based monomer having an alkyl group of 1 to 14 carbon atoms may be used. Such a (meth)acryl-based monomer more preferably has 4 to 14 carbon atoms. For example, such a (meth)acryl-based monomer may be methyl (meth)acrylate or ethyl (meth)acrylate. In particular, preferably used are n-butyl (meth)acrylate, tert-butyl (meth)acrylate, isobutyl (meth)acrylate, hexyl (meth)acrylate, 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, etc. These acryl-based monomers may be used alone or in combination of two or more.

The content of the (meth)acryl-based monomer having an alkyl group of 1 to 14 carbon atoms in the monomers is preferably 50% by weight or more, more preferably 60 to 100% by weight, even more preferably 70 to 98% by weight. Within the range, good interaction with the ionic liquid and good adherability (tackiness) can be achieved by appropriate control, which is preferred.

Additional polymerizable monomers other than the (meth)acryl-based monomer having an alkyl group of 1 to 14 carbon atoms, such as polymerizable monomers for controlling the glass transition point or peeling property of the (meth)acryl-based polymer, may also be used without affecting the effect of the invention. Such other monomers may be used alone or in any combination. The content of such other monomers is preferably less than 50% by weight based on the weight of the monomers (in total).

Examples of such other polymerizable monomers that may be used as needed include cohesive strength or heat resistance improving components such as sulfonate group-containing monomers, phosphate group-containing monomers, cyano group-containing monomers, vinyl ester monomers, and aromatic vinyl monomers; and components having a functional group capable of improving adhesive strength (adhering strength) or serving as a crosslinking base point, such as carboxyl group-containing monomers, acid anhydride group-containing monomers, amide group-containing monomers, amino group-containing monomers, epoxy group-containing monomers, N-acryloylmorpholine, and vinyl ether monomers. These monomer compounds may be used alone or in combination of two or more.

When an acrylate and/or methacrylate having an acid functional group such as a carboxyl group, a sulfonate group, or a phosphate group is used as a component to form the (meth)acryl-based polymer, the content of such an acrylate or methacrylate is preferably adjusted in such a way that the (meth)acryl-based polymer can have an acid value of 40 or less, more preferably 29 or less, even more preferably 16 or less, still more preferably 8 or less, most preferably 1 or less. If the (meth)acryl-based polymer has an acid value of more than 40, undesirable charging characteristics may be provided, which is not preferred.

In the invention, the acid value of the (meth)acryl-based polymer refers to the mg amount of potassium hydroxide required to neutralize the free fatty acids, resin acids, and other acids contained in 1 g of a sample. It is conceivable that the skeleton of the (meth)acryl-based polymer having a large acid value has a large number of carboxyl groups, sulfonate groups, or other acid groups, which can significantly interact with the ionic liquid, and thus interfere with the ionic conduction caused by the ionic liquid, which can make it impossible to obtain high antistatic performance.

For example, 2-ethylhexyl acrylate and acrylic acid may be copolymerized to form an acryl-based polymer having a carboxyl group, as an example of the (meth)acryl-based polymer with an acid value of 40 or less. In this case, such an acid value means that the amount of acrylic acid should be 5.1 parts by weight or less based on 100 parts by weight of the sum of 2-ethylhexyl acrylate and acrylic acid. The acid value can also be adjusted to 29 or less by adjusting the amount of acrylic acid to 3.7 parts by weight or less.

Examples of the sulfonic acid group-containing monomer include styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

Examples of the phosphoric acid group-containing monomer include 2-hydroxyethylacryloyl phosphate.

Examples of the cyano group-containing monomer include acrylonitrile.

Examples of vinylesters include vinyl acetate, vinyl propionate, and vinyl laurate.

Examples of the aromatic vinyl compound include styrene, chlorostyrene, chloromethylstyrene, α-methylstyrene.

Examples of the carboxyl group-containing monomer include (meth)acrylic acid, carboxyethyl (meth)acrylate, carboxypentyl (meth)acrylate, itaconic acid, maleic acid, fumaric acid, and crotonic acid.

Examples of the acid anhydride group-containing monomer include maleic acid anhydride, and itaconic acid anhydride.

Examples of the hydroxyl group-containing monomer include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate, N-methylol(meth)acrylamide, vinyl alcohol, allyl alcohol, 2-hydroxyethyl vinyl ether, 4-hydroxybutylvinyl ether, and diethylene glycol monovinyl ether.

Examples of the amido group-containing monomer include acrylamide, and diethylacrylamide.

Examples of the amino group-containing monomer include N,N-dimethylaminoethyl (meth)acrylate, and N,N-dimethylaminopropyl (meth)acrylate.

Examples of the epoxy group-containing monomer include glycidyl (meth)acrylate, and allyl glycidyl ether.

Examples of vinyl ethers include methyl vinyl ether, ethyl vinyl ether, and isobutyl vinyl ether.

The (meth)acryl-based polymer used in the invention preferably has a weight average molecular weight of 100,000 to 5,000,000, more preferably 200,000 to 4,000,000, even more preferably 300,000 to 3,000,000. If the weight average molecular weight is less than 100,000, the wettability to an adherend may be higher so that the adhesive strength (adhering strength) during peel off may be higher, which may cause damage to the adherend during the peeling process (removal) or tend to cause adhesive residue due to a decrease in the cohesive strength of the pressure-sensitive adhesive layer. On the other hand, if the weight average molecular weight is more than 5,000,000, the polymer may have lower fluidity and thus insufficient wettability to an adherend, which may tend to cause an air bubble between the adherend and the pressure-sensitive adhesive layer of the adhesive (surface protecting) film. The weight average molecular weight refers to a measurement obtained by gel permeation chromatography (GPC).

The (meth)acryl-based polymer preferably has a glass transition temperature (Tg) of 0° C. or lower (generally −100° C. or higher), more preferably −10° C. or lower, even more preferably −20° C. or lower, because with such a glass transition temperature, well-balanced adhesive performance can be easily achieved. If the glass transition temperature is higher than 0° C., the polymer can be less fluid and have insufficient wettability to an adherend, which may tend to cause an air bubble between the adherend and the pressure-sensitive adhesive layer of the adhesive (surface protecting) film. The glass transition temperature (Tg) of the (meth)acryl-based polymer can be adjusted within the range by appropriately changing the component and composition ratio of the monomers.

The production of the (meth)acryl-based polymer is not particularly limited, but for example, a known polymerization method including solution polymerization, emulsion polymerization, bulk polymerization, and suspension polymerization. The solution polymerization is more preferred in view of the workability. The resultant polymer may be any one selected from a random copolymer, a block copolymer and others.

[Ionic Liquid]

In the invention, the pressure-sensitive adhesive layer contains an ionic liquid. When an ionic liquid is used as an antistatic agent, a highly antistatic pressure-sensitive adhesive layer can be obtained without degradation of adhesive properties. Although the details of why high antistatic properties can be obtained using an ionic liquid is not clear, the molecules of an ionic liquid, which is fluid, can easily move and thus can easily rearrange themselves when charges are generated. It is therefore conceivable that even when an ionic liquid is contained in a pressure-sensitive adhesive layer, the ionic liquid can achieve molecular rearrangement to trigger a charge neutralizing mechanism, so that high antistatic performance can be obtained.

The ionic liquid, which is liquid at room temperature, can be easily added and dispersed or dissolved in a pressure-sensitive adhesive as compared with solid salts. In addition, the ionic liquid, which has no vapor pressure (or is nonvolatile), does not evaporate over time and thus is characterized in that it can maintain antistatic properties. As used herein, the term “ionic liquid” refers to a molten salt (ionic compound) in a liquid state at room temperature (25° C.)

The ionic liquid to be preferably used is composed of organic cation components represented by the following general formulas (A) to (E) and an anion component. By an ionic liquids having these cations, further excellent antistatic ability is obtained.

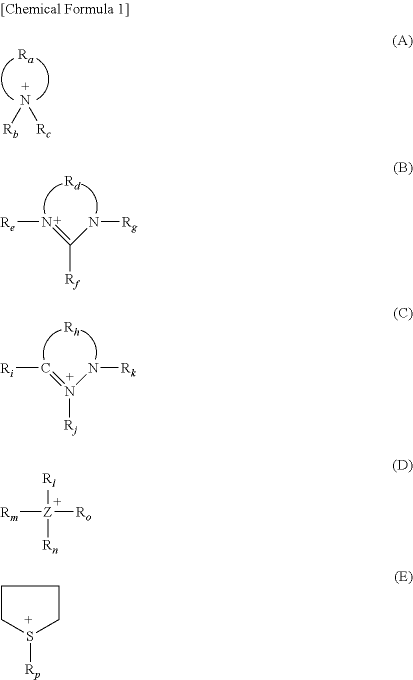

In the formula (A), Rₐ represents a hydrocarbon group of a carbon number of 4 to 20, and may contain a hetero atom, and R_{b} and R_{c} are the same or different, represent hydrogen or a hydrocarbon group of a carbon number of 1 to 16, and may contain a hetero atom, provided that, when a nitrogen atom contains a double bond, R_{c} is not present.

In the formula (B), R_{d} represents a hydrocarbon group of a carbon number of 2 to 20, and may contain a hetero atom, and Rₑ, R_{f} and R_{g} are the same or different, represent hydrogen or a hydrocarbon group of a carbon number of 1 to 16, and may contain a hetero atom.

In the formula (C), Rₕ represents a hydrocarbon group of a carbon number of 2 to 20, and may contain a hetero atom, and Rᵢ, Rⱼ and Rₖ are the same or different, represent a hydrogen or a hydrocarbon group of a carbon number of 1 to 16, and may contain a hetero atom.

In the formula (D), Z represents a nitrogen atom, a sulfur atom, or a phosphorus atom, and Rₗ, Rₘ, Rₙ and Rₒ are the same or different, represent a hydrocarbon group of a carbon number of 1 to 20, and may contain a hetero atom, provided that, when Z is a sulfur atom, Rₒ is not present.

Rₚ in the formula (E) represents a hydrocarbon group of 1 to 18 carbon atoms and may be a functional group in which a part of the hydrocarbon group is substituted with a hetero atom.

Examples of the cation represented by the formula (A) include a pyridinium cation, a piperidinium cation, a pyrrolidinium cation, a cation having a pyrroline skeleton, a cation having a pyrrole skeleton, and a morpholinium cation.

Examples include 1-ethylpyridinium cation, 1-butylpyridinium cation, 1-hexylpyridinium cation, 1-butyl-3-methylpyridinium cation, 1-butyl-4-methylpyridinium cation, 1-hexyl-3-methylpyridinium cation, 1-butyl-3,4-dimethylpyridinium cation, 1,1-dimethylpyrrolidinium cation, 1-ethyl-1-methylpyrrolidinium cation, 1-methyl-1-propylpyrrolidinium cation, 1-methyl-1-butylpyrrolidinium cation, 1-methyl-1-pentylpyrrolidinium cation, 1-methyl-1-hexylpyrrolidinium cation, 1-methyl-1-heptylpyrrolidinium cation, 1-ethyl-1-propylpyrrolidinium cation, 1-ethyl-1-butylpyrrolidinium cation, 1-ethyl-1-pentylpyrrolidinium cation, 1-ethyl-1-hexylpyrrolidinium cation, 1-ethyl-1-heptylpyrrolidinium cation, 1,1-dipropylpyrrolidinium cation, 1-propyl-1-butylpyrrolidinium cation, 1,1-dibutylpyrrolidinium cation, 1-propylpiperidinium cation, 1-pentylpiperidinium cation, 1,1-dimethylpiperidinium cation, 1-methyl-1-ethylpiperidinium cation, 1-methyl-1-propylpiperidinium cation, 1-methyl-1-butylpiperidinium cation, 1-methyl-1-pentylpiperidinium cation, 1-methyl-1-hexylpiperidinium cation, 1-methyl-1-heptylpiperidinium cation, 1-ethyl-1-propylpiperidinium cation, 1-ethyl-1-butylpiperidinium cation, 1-ethyl-1-pentylpiperidinium cation, 1-ethyl-1-hexylpiperidinium cation, 1-ethyl-1-heptylpiperidinium cation, 1,1-dipropylpiperidinium cation, 1-propyl-1-butylpiperidinium cation, 1,1-dibutylpiperidinium cation, 2-methyl-1-pyrroline cation, 1-ethyl-2-phenylindole cation, 1,2-dimethylindole cation, 1-ethylcarbazole cation, and N-ethyl-N-methylmorpholinium cation.

Examples of the cation represented by the formula (B) include an imidazolium cation, a tetrahydropyrimidinium cation, and a dihydropyrimidinium cation.

Examples include 1,3-dimethylimidazolium cation, 1,3-diethylimidazolium cation, 1-ethyl-3-methylimidazolium cation, 1-butyl-3-methylmidazolium cation, 1-hexyl-3-methylimidazolium cation, 1-octyl-3-methylimidazolium cation, 1-decyl-3-methylimidazolium cation, 1-dodecyl-3-methylimidazolium cation, 1-tetradecyl-3-methylimidazolium cation, 1,2-dimethyl-3-propylimidazolium cation, 1-ethyl-2,3-dimethylimidazolium cation, 1-butyl-2,3-dimethylimidazolium cation, 1-hexyl-2,3-dimethylimidazolium cation, 1,3-dimethyl-1,4,5,6-tetrahydropyrimidinium cation, 1,2,3-trimethyl-1,4,5,6-tetrahydropyrimidinium cation, 1,2,3,4-tetramethyl-1,4,5,6-tetrahydropyrimidinium cation, 1,2,3,5-tetramethyl-1,4,5,6-tetrahydropyrimidinium cation, 1,3-dimethyl-1,4-dihydropyrimidinium cation, 1,3-dimethyl-1,6-dihydropyrimidinium cation, 1,2,3-trimethyl-1,4-dihydropyrimidinium cation, 1,2,3-trimethyl-1,6-dihydropyrimidinium cation, 1,2,3,4-tetramethyl-1,4-dihydropyrimidinium cation, and 1,2,3,4-tetramethyl-1,6-dihydropyrimidinium cation.

Examples of the cation represented by the formula (C) include a pyrazolium cation, and a pyrazolinium cation.

Examples include 1-methylpyrazolium cation, 3-methylpyrazolium cation, 1-ethyl-2-methylpyrazolinium cation, 1-ethyl-2,3,5-trimethylpyrazolium cation, 1-propyl-2,3,5-trimethylpyrazolium cation, 1-butyl-2,3,5-trimethylpyrazolium cation, 1-ethyl-2,3,5-trimethylpyrazolinium cation, 1-propyl-2,3,5-trimethylpyrazolinium cation, and 1-butyl-2,3,5-trimethylpyrazolinium cation.

Examples of the cation represented by the formula (D) include a tetraalkylammonium cation, a trialkylsulfonium cation, a tetraalkylphosphonium cation, and those cations in which a part of the alkyl group is substituted with an alkenyl group, an alkoxyl group, or an epoxy group.

Examples include tetramethylammonium cation, tetraethylammonium cation, tetrabutylammonium cation, tetrapentylammonium cation, tetrahexylammonium cation, tetraheptylammonium cation, triethylmethylammonium cation, tributylethylammonium cation, trimethyldecylammonium cation, N,N-diethyl-N-methyl-N-(2-methoxyethyl)ammonium cation, glycidyltrimethylammonium cation, trimethylsulfonium cation, triethylsulfonium cation, tributylsulfonium cation, trihexylsulfonium cation, diethylmethylsulfonium cation, dibutylethylsulfonium cation, dimethyldecylsulfonium cation, tetramethylphosphonium cation, tetraethylphosphonium cation, tetrabutylphosphonium cation, tetrahexylphosphonium cation, tetraoctylphosphonium cation, triethylmethylphosphonium cation, tributylethylphosphonium cation, trimethyldecylphosphonium cation, and diallyldimethylammonium cation. In particular, preferably used is asymmetric tetraalkylammonium cation such as triethylmethylammonium cation, tributylethylammonium cation, trimethyldecylammonium cation, diethylmethylsulfonium cation, dibutylethylsulfonium cation, dimethyldecylsulfonium cation, triethylmethylphosphonium cation, tributylethylphosphonium cation, or trimethyldecylphosphonium cation, trialkylsulfonium cation, tetraalkylphosphonium cation, N,N-diethyl-N-methyl-N-(2-methoxyethyl)ammonium cation, glycidyltrimethylammonium cation, diallyldimethylammonium cation, N,N-dimethyl-N-ethyl-N-propylammonium cation, N,N-dimethyl-N-ethyl-N-butylammonium cation, N,N-dimethyl-N-ethyl-N-pentylammonium cation, N,N-dimethyl-N-ethyl-N-hexylammonium cation, N,N-dimethyl-N-ethyl-N-heptylammonium cation, N,N-dimethyl-N-ethyl-N-nonylammonium cation, N,N-dimethyl-N,N-dipropylammonium cation, N,N-diethyl-N-propyl-N-butylammonium cation, N,N-dimethyl-N-propyl-N-pentylammonium cation, N,N-dimethyl-N-propyl-N-hexylammonium cation, N,N-dimethyl-N-propyl-N-heptylammonium cation, N,N-dimethyl-N-butyl-N-hexylammonium cation, N,N-diethyl-N-butyl-N-heptylammonium cation, N,N-dimethyl-N-pentyl-N-hexylammonium cation, N,N-dimethyl-N,N-dihexylammonium cation, trimethylheptylammonium cation, N,N-diethyl-N-methyl-N-propylammonium cation, N,N-diethyl-N-methyl-N-pentylammonium cation, N,N-diethyl-N-methyl-N-heptylammonium cation, N,N-diethyl-N-propyl-N-pentylammonium cation, triethylpropylammonium cation, triethylpentylammonium cation, triethylheptylammonium cation, N,N-dipropyl-N-methyl-N-ethylammonium cation, N,N-dipropyl-N-methyl-N-pentylammonium cation, N,N-dipropyl-N-butyl-N-hexylammonium cation, N,N-dipropyl-N,N-dihexylammonium cation, N,N-dibutyl-N-methyl-N-pentylammonium cation, N,N-dibutyl-N-methyl-N-hexylammonium cation, trioctylmethylammonium cation, or N-methyl-N-ethyl-N-propyl-N-pentylammonium cation.

The cation represented by the formula (E) includes, for example, a sulfonium cation. Specific examples of Rp in the formula (E) include a methyl group, an ethyl group, a propyl group, a butyl group, a hexyl group, an octyl group, a nonyl group, a decyl group, a dodecyl group, a tridecyl group, a tetradecyl group, an octadecyl group and the like.

On the other hand, the anionic component is not particularly limited as far as it satisfies that it becomes an ionic liquid. Specifically, for example, Cl⁻, Br⁻, I⁻, AlCl₄⁻, Al₂Cl₇⁻, BF₄⁻, PF₆⁻, ClO₄⁻, NO₃⁻, CH₃COO⁻, CF₃COO⁻, CH₃SO₃⁻, (CF₃SO₂)₂N⁻, (CF₃SO₂)₃C⁻, AsF₆⁻, SbF₆⁻, NbF₆⁻, TaF₆⁻, F(HF)ₙ⁻, (CN)₂N⁻, C₄F₉SO₃⁻, (C₂F₅SO₂)₂N⁻, C₃F₇COO⁻, (CF₃SO₂)(CF₃CO)N⁻, C₉H₁₉OSO₃, (CH₃)₂PO₄⁻, (C₂H₅)₂PO₄⁻, C₂H₅OSO₃⁻, C₆H₁₃OSO₃⁻, C₈H₁₇OSO₃, CH₃(OC₂H₄)₂OSO₃⁻, C₆H₄(CH₃)SO₃⁻, (C₂F₅)₃PF₃⁻, CH₃CH(OH)COO⁻, and (FSO₂)₂N⁻ are used.

It is also possible to use, as an anion component, an anion represented by the following formula (F).

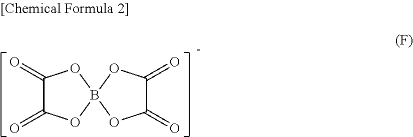

An anion component having a fluorine atom is particularly preferably used as the anion component since an ionic liquid having a low melting point can be obtained.

Examples of the ionic liquid used in the invention may be appropriately selected from combinations of any of the above cationic components and any of the above anionic components. Such examples include 1-butylpyridinium tetrafluoroborate, 1-butylpyridinium hexafluorophosphate, 1-butyl-3-methylpyridinium tetrafluoroborate, 1-butyl-3-methylpyridinium trifluoromethanesulfonate, 1-butyl-3-methylpyridinium bis(trifluoromethanesulfonyl)imide, 1-butyl-3-methylpyridinium bis(pentafluoroethanesulfonyl)imide, 1-hexylpyridinium tetrafluoroborate, 1,1-dimethylpyrrolidinium bis(trifluoromethanesulfonyl)imide, 1-methyl-1-ethylpyrrolidinium bis(trifluoromethanesulfonyl)imide, 1-methyl-1-propylpyrrolidinium bis(trifluoromethanesulfonyl)imide, 1-methyl-1-butylpyrrolidinium bis(trifluoromethanesulfonyl)imide, 1-methyl-1-pentylpyrrolidinium bis(trifluoromethanesulfonyl)imide, 1-methyl-1-hexylpyrrolidinium bis(trifluoromethanesulfonyl)imide, 1-methyl-1-heptylpyrrolidinium bis(trifluoromethanesulfonyl)imide, 1-ethyl-1-propylpyrrolidinium bis(trifluoromethanesulfonyl)imide, 1-ethyl-1-butylpyrrolidinium bis(trifluoromethanesulfonyl)imide, 1-ethyl-1-pentylpyrrolidinium bis(trifluoromethanesulfonyl)imide, 1-ethyl-1-hexylpyrrolidinium bis(trifluoromethanesulfonyl)imide, 1-ethyl-1-heptylpyrrolidinium bis(trifluoromethanesulfonyl)imide, 1,1-dipropylpyrrolidinium bis(trifluoromethanesulfonyl)imide, 1-propyl-1-butylpyrrolidinium bis(trifluoromethanesulfonyl)imide, 1,1-dibutylpyrrolidinium bis(trifluoromethanesulfonyl)imide, 1-propylpiperidinium bis(trifluoromethanesulfonyl)imide, 1-pentylpiperidinium bis(trifluoromethanesulfonyl)imide, 1,1-dimethylpiperidinium bis(trifluoromethanesulfonyl)imide, 1-methyl-1-ethylpiperidinium bis(trifluoromethanesulfonyl)imide, 1-methyl-1-propylpiperidinium bis(trifluoromethanesulfonyl)imide, 1-methyl-1-butylpiperidinium bis(trifluoromethanesulfonyl)imide, 1-methyl-1-pentylpiperidinium bis(trifluoromethanesulfonyl)imide, 1-methyl-1-hexylpiperidinium bis(trifluoromethanesulfonyl)imide, 1-methyl-1-heptylpiperidinium bis(trifluoromethanesulfonyl)imide, 1-ethyl-1-propylpiperidinium bis(trifluoromethanesulfonyl)imide, 1-ethyl-1-butylpiperidinium bis(trifluoromethanesulfonyl)imide, 1-ethyl-1-pentylpiperidinium bis(trifluoromethanesulfonyl)imide, 1-ethyl-1-hexylpiperidinium bis(trifluoromethanesulfonyl)imide, 1-ethyl-1-heptylpiperidinium bis(trifluoromethanesulfonyl)imide, 1,1-dipropylpiperidinium bis(trifluoromethanesulfonyl)imide, 1-propyl-1-butylpiperidinium bis(trifluoromethanesulfonyl)imide, 1,1-dibutylpiperidinium bis(trifluoromethanesulfonyl)imide, 1,1-dimethylpyrrolidinium bis(pentafluoroethanesulfonyl)imide, 1-methyl-1-ethylpyrrolidinium bis(pentafluoroethanesulfonyl)imide, 1-methyl-1-propylpyrrolidinium bis(pentafluoroethanesulfonyl)imide, 1-methyl-1-butylpyrrolidinium bis(pentafluoroethanesulfonyl)imide, 1-methyl-1-pentylpyrrolidinium bis(pentafluoroethanesulfonyl)imide, 1-methyl-1-hexylpyrrolidinium bis(pentafluoroethanesulfonyl)imide, 1-methyl-1-heptylpyrrolidinium bis(pentafluoroethanesulfonyl)imide, 1-ethyl-1-propylpyrrolidinium bis(pentafluoroethanesulfonyl)imide, 1-ethyl-1-butylpyrrolidinium bis(pentafluoroethanesulfonyl)imide, 1-ethyl-1-pentylpyrrolidinium bis(pentafluoroethanesulfonyl)imide, 1-ethyl-1-hexylpyrrolidinium bis(pentafluoroethanesulfonyl)imide, 1-ethyl-1-heptylpyrrolidinium bis(pentafluoroethanesulfonyl)imide, 1,1-dipropylpyrrolidinium bis(pentafluoroethanesulfonyl)imide, 1-propyl-1-butylpyrrolidinium bis(pentafluoroethanesulfonyl)imide, 1,1-dibutylpyrrolidinium bis(pentafluoroethanesulfonyl)imide, 1-propylpiperidinium bis(pentafluoroethanesulfonyl)imide, 1-pentylpiperidinium bis(pentafluoroethanesulfonyl)imide, 1,1-dimethylpiperidinium bis(pentafluoroethanesulfonyl)imide, 1-methyl-1-ethylpiperidinium bis(pentafluoroethanesulfonyl)imide, 1-methyl-1-propylpiperidinium bis(pentafluoroethanesulfonyl)imide, 1-methyl-1-butylpiperidinium bis(pentafluoroethanesulfonyl)imide, 1-methyl-1-pentylpiperidinium bis(pentafluoroethanesulfonyl)imide, 1-methyl-1-hexylpiperidinium bis(pentafluoroethanesulfonyl)imide, 1-methyl-1-heptylpiperidinium bis(pentafluoroethanesulfonyl)imide, 1-ethyl-1-propylpiperidinium bis(pentafluoroethanesulfonyl)imide, 1-ethyl-1-butylpiperidinium bis(pentafluoroethanesulfonyl)imide, 1-ethyl-1-pentylpiperidinium bis(pentafluoroethanesulfonyl)imide, 1-ethyl-1-hexylpiperidinium bis(pentafluoroethanesulfonyl)imide, 1-ethyl-1-heptylpiperidinium bis(pentafluoroethanesulfonyl)imide, 1,1-dipropylpiperidinium bis(pentafluoroethanesulfonyl)imide, 1-propyl-1-butylpiperidinium bis(pentafluoroethanesulfonyl)imide, 1,1-dibutylpiperidinium bis(pentafluoroethanesulfonyl)imide, 2-methyl-1-pyrroline tetrafluoroborate, 1-ethyl-2-phenylindole tetrafluoroborate, 1,2-dimethylindole tetrafluoroborate, 1-ethylcarbazole tetrafluoroborate, 1-ethyl-2-methylimidazolium tetrafluoroborate, 1-ethyl-2-methylimidazolium acetate, 1-ethyl-2-methylimidazolium trifluoroacetate, 1-ethyl-2-methylimidazolium heptafluorobutyrate, 1-ethyl-2-methylimidazolium trifluoromethanesulfonate, 1-ethyl-2-methylimidazolium perfluorobutanesulfonate, 1-ethyl-2-methylimidazolium dicyanamide, 1-ethyl-2-methylimidazolium bis(trifluoromethanesulfonyl)imide, 1-ethyl-2-methylimidazolium bis(pentafluoroethanesulfonyl)imide, 1-ethyl-2-methylimidazolium tris(trifluoromethanesulfonyl)methide, 1-butyl-2-methylimidazolium tetrafluoroborate, 1-butyl-2-methylimidazolium hexafluorophosphate, 1-butyl-2-methylimidazolium trifluoroacetate, 1-butyl-2-methylimidazolium heptafluorobutyrate, 1-butyl-2-methylimidazolium trifluoromethanesulfonate, 1-butyl-2-methylimidazolium perfluorobutanesulfonate, 1-butyl-2-methylimidazolium bis(trifluoromethanesulfonyl)imide, 1-hexyl-2-methylimidazolium bromide, 1-hexyl-2-methylimidazolium chloride, 1-hexyl-2-methylimidazolium tetrafluoroborate, 1-hexyl-2-methylimidazolium hexafluorophosphate, 1-hexyl-2-methylimidazolium trifluoromethanesulfonate, 1-octyl-2-methylimidazolium tetrafluoroborate, 1-octyl-2-methylimidazolium hexafluorophosphate, 1-hexyl-2,2-dimethylimidazolium tetrafluoroborate, 1,2-dimethyl-2-propylimidazolium bis(trifluoromethanesulfonyl)imide, 1-methylpyrazolium tetrafluoroborate, 2-methylpyrazolium tetrafluoroborate, 1-ethyl-2,3,5-trimethylpyrazolium bis(trifluoromethanesulfonyl)imide, 1-propyl-2,3,5-trimethylpyrazolium bis(trifluoromethanesulfonyl)imide, 1-butyl-2,3,5-trimethylpyrazolium bis(trifluoromethanesulfonyl)imide, 1-ethyl-2,3,5-trimethylpyrazolium bis(pentafluoroethanesulfonyl)imide, 1-propyl-2,3,5-trimethylpyrazolium bis(pentafluoroethanesulfonyl)imide, 1-butyl-2,3,5-trimethylpyrazolium bis(pentafluoroethanesulfonyl)imide, 1-ethyl-2,3,5-trimethylpyrazolium bis(trifluoromethanesulfonyl)trifluoroacetamide, 1-propyl-2,3,5-trimethylpyrazolium bis(trifluoromethanesulfonyl)trifluoroacetamide, 1-butyl-2,3,5-trimethylpyrazolium bis(trifluoromethanesulfonyl)trifluoroacetamide, 1-ethyl-2,3,5-trimethylpyrazolinium bis(trifluoromethanesulfonyl)imide, 1-propyl-2,3,5-trimethylpyrazolinium bis(trifluoromethanesulfonyl)imide, 1-butyl-2,3,5-trimethylpyrazolinium bis(trifluoromethanesulfonyl)imide, 1-ethyl-2,3,5-trimethylpyrazolinium bis(pentafluoroethanesulfonyl)imide, 1-propyl-2,3,5-trimethylpyrazolinium bis(pentafluoroethanesulfonyl)imide, 1-butyl-2,3,5-trimethylpyrazolinium bis(pentafluoroethanesulfonyl)imide, 1-ethyl-2,3,5-trimethylpyrazolinium bis(trifluoromethanesulfonyl)trifluoroacetamide, 1-propyl-2,3,5-trimethylpyrazolinium bis(trifluoromethanesulfonyl)trifluoroacetamide, 1-butyl-2,3,5-trimethylpyrazolinium bis(trifluoromethanesulfonyl)trifluoroacetamide, tetrapentylammonium trifluoromethanesulfonate, tetrapentylammonium bis(trifluoromethanesulfonyl)imide, tetrahexylammonium trifluoromethanesulfonate, tetrahexylammonium bis(trifluoromethanesulfonyl)imide, tetraheptylammonium trifluoromethanesulfonate, tetraheptylammonium bis(trifluoromethanesulfonyl)imide, diallyldimethylammonium tetrafluoroborate, diallyldimethylammonium trifluoromethanesulfonate, diallyldimethylammonium bis(trifluoromethanesulfonyl)imide, diallyldimethylammonium bis(pentafluoroethanesulfonyl)imide, N,N-diethyl-N-methyl-N-(2-methoxyethyl)ammonium tetrafluoroborate, N,N-diethyl-N-methyl-N-(2-methoxyethyl)ammonium trifluoromethanesulfonate, N,N-diethyl-N-methyl-N-(2-methoxyethyl)ammonium bis(trifluoromethanesulfonyl)imide, N,N-diethyl-N-methyl-N-(2-methoxyethyl)ammonium bis(pentafluoroethanesulfonyl)imide, glycidyltrimethylammonium trifluoromethanesulfonate, glycidyltrimethylammonium bis(trifluoromethanesulfonyl)imide, glycidyltrimethylammonium bis(pentafluoroethanesulfonyl)imide, tetraoctylphosphonium trifluoromethanesulfonate, tetraoctylphosphonium bis(trifluoromethanesulfonyl)imide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, 1-butylpyridinium (trifluoromethanesulfonyl)trifluoroacetamide, 1-butyl-3-methylpyridinium (trifluoromethanesulfonyl)trifluoroacetamide, 1-ethyl-3-methylimidazolium (trifluoromethanesulfonyl)trifluoroacetamide, N-ethyl-N-methylmorpholinium thiocyanate, and 4-ethyl-4-methylmorpholinium methylcarbonate.

As the aforementioned ionic liquid, a commercially available ionic liquid may be used, or the liquid may be synthesized as described below. A method of synthesizing an ionic liquid is not particularly limited as far as an objective ionic liquid is obtained. Generally, a halide method, a hydroxide method, an acid ester method, a chelate forming method, and a neutralization method described in the publication “Ionic liquid—The Front and Future of Development—” (published by CMC) are used.

Regarding a halide method, a hydroxide method, an acid ester method, a chelate forming method, and a neutralization method, a synthesis method using an example of a nitrogen-containing onium salt will be shown below, but other ionic liquid such as a sulfur-containing onium salt, and a phosphorus-containing onium salt can be obtained by the similar procedure.

The halide method is a method which is performed by a reaction shown in the following formulas (1) to (3). First, a tertiary amine and alkyl halide are reacted to obtain halide (Reaction Equation (1), as a halogen, chlorine, bromine or iodine is used). The resulting halide is reacted with an acid (HA) having an anion structure (A⁻) of an objective ionic liquid or a salt (MA, M is a cation forming a salt with an objective anion such as ammonium, lithium, sodium and potassium) of an objective ionic liquid to obtain an objective ionic liquid (R₄NA).

[Chemical formula 3]

R₃N+RX→R₄NX (X: Cl, Br, I) (1)

R₄NX+HA→R₄NA+HX (2)

R₄NX+MA→R₄NA+MX (M: NH₄, Li, Na, K, Ag etc.) (3)

The hydroxide method is a method performed by a reaction shown in (4) to (8). First, a halide (R₄NX) is subjected to ion exchange membrane method electrolysis (reaction equation (4)), an OH-type ion exchange resin method (reaction equation (5)) or a reaction with silver oxide (Ag₂O) (reaction equation (6)) to obtain a hydroxide (R₄NOH) (as a halogen, chlorine, bromine or iodine is used).

The resulting hydroxide is subjected to a reaction of reaction equations (7) to (8) as in the aforementioned halide method to obtain an objective ionic liquid (R₄NA).

[Chemical formula 4]

R₄NX+H₂O→R₄NOH+½H₂+½X₂ (X: Cl, Br, I) (4)

R₄NX+P—OH→R₄NOH+P—X (P—OH: OH-type ion exchange resin) (5)

R₄NX+½Ag₂O+½H₂O→R₄NOH+AgX (6)

R₄NOH+HA→R₄NA+H₂O (7)

R₄NOH+MA→R₄NA+MOH (M: NH₄, Li, Na, K, Ag etc.) (8)

The acid ester method is a method performed by a reaction shown in (9) to (11). First, tertiary amine (R₃N) is reacted with acid ester to obtain an acid esterified substance (reaction equation (9), as acid ester, ester of an inorganic acid such as sulfuric acid, sulfurous acid, phosphoric acid, phosphorous acid, and carbonic acid, or ester of organic acid such as methanesulfonic acid, methylphosphonic acid and formic acid is used). The resulting acid esterified substance is subjected to a reaction of reaction equations (10) to (11) as in the aforementioned halide method, to obtain an objective ionic liquid (R₄NA). Alternatively, as acid ester, methyl trifluoromethanesulfonate, or methyl trifluoroacetate may be used to directly obtain an ionic liquid.

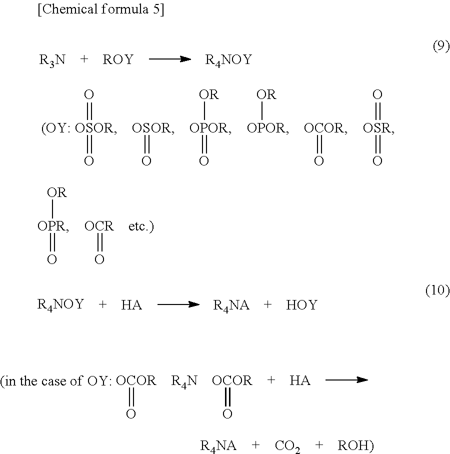

R₄NOY+MA→R₄NA+MOY (M: NH₄, Li, Na, K, Ag etc.) (11)

The chelate forming method is a method performed by a reaction as shown in (12) to (15). First, halide of quaternary ammonium (R₄NX), hydroxide of quaternary ammonium (R₄NOH), or carbonic acid esterified substance of quaternary ammonium (R₄NOCO₂CH₃) is reacted with hydrogen fluoride (HF) or ammonium fluoride (NH₄F) to obtain a quaternary ammonium fluoride salt (reaction equation (12) to (14)). The resulting quaternary ammonium fluoride salt can be subjected to a chelate forming reaction with fluoride such as BF₃, AlF₃, PF₅, AsF₅, SbF₅, NbF₅ and TaF₆, to obtain an ionic liquid (reaction equation (15)).

[Chemical formula 6]

R₄NX+HF→R₄NF+HX (X: Cl, Br, I) (12)

R₄NY+HF→R₄NF+HY (Y: OH, OCO₂CH₃) (13)

R₄NY+NH₄F→R₄NF+NH₃+HY (Y: OH, OCO₂CH₃) (14)

R₄NF+MFₙ₋₁→R₄NMFₙ (15)

### (MFₙ₋₁: BF₃, AlF₃, PF₅, ASF₅, SbF₅, NbF₅, TaF₅ etc.)

The neutralization method is a method performed by a reaction shown in (16). An ionic liquid can be obtained by reacting tertiary amine and an organic acid such as HBF₄, HPF₆, CH₃COOH, CF₃COOH, CF₃SO₃H, (CF₃SO₂)₂NH, (CF₃SO₂)₃CH, and (C₂F₅SO₂)₂NH.

[Chemical formula 7]

R₃N+HZ→R₃HN⁺Z⁻ (16)

[HZ: HBF₄, HPF₆, CH₃COOH, CF₃COOH, CF₃SO₃H, (CF₃SO₂)₂NH, (CF₃SO₂)₃CH, (C₂F₅SO₂)₂NH organic acid such as]

The aforementioned R in (1) to (16) represents hydrogen or a hydrocarbon group of a carbon number of 1 to 20, and a part of the hydrocarbon group may be functional group substituted with a hetero atom.

The content of the ionic liquid is preferably from 0.01 to 2.5 parts by weight, more preferably from 0.05 to 2.4 parts by weight, even more preferably from 0.1 to 2.2 parts by weight, based on 100 parts by weight of the (meth)acryl-based polymer. If the content is less than 0.01 parts by weight, it can be difficult to obtain sufficient antistatic properties. If the content is more than 2.5 parts by weight, staining on an adherend may increase, or adhesive strength may decrease, which is not preferred because in some cases, sufficient adhesive properties (adhesion) cannot be achieved on an adherend (e.g., diffusion sheet) having unevenness on its surface (or having a non-smooth surface).

[Crosslinking Agent]

The pressure-sensitive adhesive layer used in the invention contains a crosslinking agent. The addition of the crosslinking agent makes it possible to crosslink the (meth)acryl-based polymer and thus to obtain a pressure-sensitive adhesive layer with a high level of heat resistance and removability.

The crosslinking agent used in the invention may be any of an isocyanate compound, an epoxy compound, a melamine resin, an aziridine derivative, a metal chelate compound, and other compounds. In particular, an isocyanate compound or an epoxy compound is preferably used mainly in terms of obtaining an adequate level of cohesive strength. These compounds may be used alone or in combination of two or more.

Examples of isocyanate compounds include lower aliphatic polyisocyanates such as butylene diisocyanate and hexamethylene diisocyanate; alicyclic isocyanates such as cyclopentylene diisocyanate, cyclohexylene diisocyanate, and isophorone diisocyanate; aromatic isocyanates such as 2,4-tolylene diisocyanate, 4,4′-diphenylmethane diisocyanate, and xylylene diisocyanate; and isocyanate adducts such as a trimethylolpropane-tolylene diisocyanate trimer adduct (CORONATE L (trade name) manufactured by NIPPON POLYURETHANE INDUSTRY CO., LTD.), a trimethylolpropane-hexamethylene diisocyanate trimer adduct (CORONATE HL (trade name) manufactured by NIPPON POLYURETHANE INDUSTRY CO., LTD.), and an isocyanurate of hexamethylene diisocyanate (CORONATE HX (trade name) manufactured by NIPPON POLYURETHANE INDUSTRY CO., LTD.). These compounds may be used alone or in combination of two or more.

Examples of the epoxy compound include N,N,N′,N′-tetraglycidyl-m-xylenediamine (trade name TETRAD-X manufactured by Mitsubishi Gas Chemical Company, Inc.) and 1,3-bis(N,N-diglycidylaminomethyl)cyclohexane (trade name TETRAD-C manufactured by Mitsubishi Gas Chemical Company Inc.). These compounds may be used alone, or may be used by mixing two or more kinds.

Examples of the melamine-based resin include hexamethylolmelamine. Examples of the aziridine derivative include trade name HDU (manufactured by Sogo Pharmaceutical Co., Ltd.), trade name TAZM (manufactured by Sogo Pharmaceutical Co., Ltd.), and trade name TAZO (manufactured by Sogo Pharmaceutical Co., Ltd.) as a commercially available product. These compounds may be used alone, or may be used by mixing two or more kinds.

Metal chelate compounds include a metal component such as aluminum, iron, tin, titanium, or nickel, and a chelate component such as acetylene, methyl acetoacetate, ethyl lactate, or acetylacetone. These compounds may be used alone or in a mixture of two or more.

In an embodiment of the present invention, a polyfunctional monomer having two or more radiation-reactive unsaturated bonds may be added as a crosslinking agent to the pressure-sensitive adhesive composition. In this case, the pressure-sensitive adhesive composition may be crosslinked by application of radiations. A single molecule of the polyfunctional monomer may have two or more radiation-reactive unsaturated bonds derived from one or more radiation-crosslinkable (curable) moieties such as vinyl, acryloyl, methacryloyl, and vinylbenzyl groups. The polyfunctional monomer that may be preferably used generally has 10 or less radiation-reactive unsaturated bonds. These compounds may be used alone or in a mixture of two or more.

Examples of the polyfunctinal monomer include ethylene glycol di(meth)acrylate, diethlene glycol di(meth)acrylate, tetraethylene glycol di(meth)acrylate, neopentyl glycol di(meth)acrylate, 1,6-hexanediol di(meth)acrylate, trimethylolpropane tri(meth)acrylate, pentaerythritol tri(meth)acrylate, dipentaerythritol hexa(meth)acrylate, divinylbenzene, and N,N′-methylenebisacrylamide.

The content of the crosslinking agent used in the invention is 2 parts by weight or less, preferably from 0.05 to 1.5 parts by weight, more preferably from 0.1 to 1 part by weight, based on 100 parts by weight of the (meth)acryl-based polymer. Within the range, a pressure-sensitive adhesive layer with a high level of heat resistance and removability can be obtained, which is useful. If the content of the crosslinking agent is less than 0.05 parts by weight, the crosslinking agent may form cross-links insufficiently, so that the pressure-sensitive adhesive layer may have low cohesive strength, which may result in insufficient heat resistance or tend to cause adhesive residue. If the content of the crosslinking agent is more than 2 parts by weight, the pressure-sensitive adhesive layer may have higher cohesive strength, lower fluidity, and insufficient wettability to an adherend having a rough surface, such as a diffusion sheet, so that lifting may occur at ends, which is not preferred. These crosslinking agents may be used alone or in combination of two or more.

Examples of radiation include ultraviolet ray, laser ray, α ray, β ray, γ ray, X-ray, and electron beam. From a viewpoint of controlling property and better handling property and a cost, ultraviolet ray is suitably used. More preferably, ultraviolet ray having a wavelength of 200 to 400 nm is used. Ultraviolet ray can be irradiated using an appropriate light source such as a high pressure mercury lamp, a micro-wave excitation-type lamp, and a chemical lamp. When ultraviolet ray is used as irradiation, a photopolymerization initiator is added to an acryl pressure-sensitive adhesive layer. These photopolymerization initiators may be used alone or in combination of two or more.

The photopolymerization initiator depends on a kind of a radiation-reactive component, and may be a substance which produces a radical or a cation by irradiating ultraviolet ray having an appropriately wavelength which can trigger the polymerization reaction.

Example of the photoradical polymerization initiator include benzoins such as benzoin, benzoin methyl ether, benzoin ethyl ether, methyl o-benzoylbenzoate-p-benzoin ethyl ether, benzoin isopropyl ether, and α-methylbenzoin, acetophenes such as benzylmethylketal, trichloroacetophenone, 2,2-diethoxyacetophenone, and 1-hydroxycyclohexyl phenyl ketone, propiophenones such as 2-hydroxy-2-methylpropiophenone, and 2-hydroxy-4′-isopropyl-2-methylpropiophenone, benzophenones such as benzophenone, methylbenzophenone, p-chlorobenzophenone, and p-dimethylaminobenzophenone, thioxanthons such as 2-chlorothioxanthon, 2-ethylthioxanthon, and 2-isopropylthioxanthon, acylphosphine oxides such as bis(2,4,6-trimethylbenzoyl)-phenylphosphine oxide, 2,4,6-trimethylbenzoyldiphenylphosphine oxide, and (2,4,6-trimethylbenzoyl)-(ethoxy)-phenylphosphine oxide, benzil, dibenzsuberone, and α-acyloxime ether. These compounds may be used alone or in a mixture of two or more.

Examples of a photocation polymerization initiator include onium salts such as an aromatic diazonium salt, an aromatic iodonium salt, and an aromatic sulfonium salt, organometallic complexes such as an ion-allene complex. a titanocene complex, and an aryl silanol-aluminum complex, nitrobenzyl ester, sulfonic acid derivative, phosphoric acid ester, phenolsulfonic acid ester, diazonaphthoquinone, and N-hydroxymidosulfonate. These compounds may be used alone or in a mixture of two or more. It is preferably that the photopolymerization initiator is blended usually in a range of 0.1 to 10 parts by weight, preferably 0.2 to 7 parts by weight relative to 100 parts by weight of a (meth)acryl-based polymer.

Further, it is also possible to use a photoinitiation polymerization assistant such as amines. Examples of the photoinitiation assistant include 2-dimethylaminoethyl benzoate, diemethylaminoacetophenone, p-dimethylaminobenzoic acid ethyl ester, and p-dimethylaminobenzoic acid isoamyl ester. These compounds may be used alone or in a mixture of two or more.

It is preferably that the polymerization initiation assistant is blended at 0.05 to 10 parts by weight, further 0.1 to 7 parts by weight relative to 100 parts by weight a (meth)acryl-based polymer.

The pressure-sensitive adhesive layer used in the invention may further contain a polyether polyol as an optional component, if necessary, for the purpose of further improving the antistatic effect on an adherend.

The polyether polyol may be any type of ether group-containing polymer polyol, examples of which include polyethylene glycol, polypropylene glycol (diol type), polypropylene glycol (triol type), polytetramethylene ether glycol, and derivatives or copolymers thereof. In particular, polyethylene glycol, polypropylene glycol (diol type), polypropylene glycol (triol type), and polyethylene glycol-polypropylene glycol copolymers are preferably used. These polyether polyols may be used alone or in combination of two or more.

The polyether polyol should have a number average molecular weight of 10,000 or less, preferably 200 to 5,000 so that it can be advantageously used. If its molecular weight is more than 10,000, it may tend to increase staining on an adherend.

The content of the polyether polymer is preferably 50 parts by weight or less, more preferably from 1 to 50 parts by weight, even more preferably from 3 to 20 parts by weight, based on 100 parts by weight of the acryl-based polymer. If the content is more than 50 parts by weight, staining on an adherend may increase.

The raw material (pressure-sensitive adhesive composition) for the pressure-sensitive adhesive (layer) used in the invention may also contain any other known additive. Examples of such an additive include a crosslinking catalyst, a crosslinking retarder, a powder of a colorant, a pigment, or the like, a surfactant, a plasticizer, a tackifier, a low-molecular-weight polymer, a surface lubricant, a leveling agent, an antioxidant, a corrosion inhibitor, a light stabilizer, an ultraviolet absorber, a polymerization inhibitor, a silane coupling agent, an inorganic or organic filler, a metal powder, and a particulate or flaky material, which may be added as appropriate depending on the intended use.

The pressure-sensitive adhesive layer used in the invention can be obtained by crosslinking the raw material (pressure-sensitive adhesive composition) described above for the pressure-sensitive adhesive (layer). The pressure-sensitive adhesive film (surface protective film) of the invention can be obtained by forming the pressure-sensitive adhesive layer on a substrate (support film). In this process, the pressure-sensitive adhesive composition is generally crosslinked after the composition is applied. Alternatively, however, a pressure-sensitive adhesive layer made of the crosslinked pressure-sensitive adhesive composition may also be transferred onto the substrate (support film) or the like.

When a photopolymerization initiator as an optional component is added as mentioned above, the pressure-sensitive adhesive composition may be applied directly onto an object to be protected (adherend) or applied to one or both sides of a support film and then irradiated with light so that a pressure-sensitive adhesive layer can be obtained. In general, the pressure-sensitive adhesive composition is photo-polymerized by irradiation with about 400 to about 4,000 mJ/cm² of ultraviolet light with an irradiance of 1 to 200 mW/cm² at a wavelength of 300 to 400 nm, so that the pressure-sensitive adhesive layer is obtained.

The pressure-sensitive adhesive layer may be formed on the substrate (support film) using any method. For example, the pressure-sensitive adhesive layer is formed on the substrate by a process including applying the pressure-sensitive adhesive composition to the substrate (support film) and removing the polymerization solvent and so on by drying. Subsequently, curing may be performed to control the migration of the components in the pressure-sensitive adhesive layer or to control the crosslinking reaction. When the pressure-sensitive adhesive composition is applied to the substrate to form a pressure-sensitive adhesive film (surface protective film), one or more solvents other than the polymerization solvent may be newly added to the composition so that the composition can be uniformly applied to the substrate.

In the invention, the pressure-sensitive adhesive layer may be formed using known methods for producing pressure-sensitive adhesive tapes. Examples of such methods include roll coating, gravure coating, reverse coating, roll brushing, spray coating, air knife coating, etc.

The pressure-sensitive adhesive film of the invention is generally made in such a way that the pressure-sensitive adhesive layer generally has a thickness of 3 to 100 μm, preferably about 5 to about 50 μm. The pressure-sensitive adhesive film can be in the form of a sheet or tape, which includes a substrate (support film) made of any of various materials including a plastic film such as a polyester film, a paper sheet, and a porous material such as a nonwoven fabric and the pressure-sensitive adhesive layer or layers applied and formed on one or both sides of the substrate. Particularly when the pressure-sensitive adhesive film is used as a surface protective film, a plastic substrate is used as the substrate.

The substrate (support film) used to form the surface protective film is preferably a resin film having heat resistance, solvent resistance, and flexibility. When the substrate has flexibility, the pressure-sensitive adhesive composition can be applied to the substrate using a roll coater or the like, and the product can be wound into a roll.

The plastic substrate is not particularly limited as far as it can be formed into a sheet or a film, and examples include a polyolefin film such as polyethylene, polypropylene, poly-1-butene, poly-4-methyl-1-pentene, an ethylene.propylene copolymer, an ethylene.1-butene copolymer, an ethylene.vinyl acetate copolymer, an ethylene.ethyl acrylate copolymer, and an ethylene.vinyl alcohol copolymer, a polyester film such as polyethylene terephthalate, polyethylene naphthalate, and polybutylene terephthalate, a polyacrylate film, a polyurethane film, a polystyrene film, a polyamide film such as nylon 6, nylon 6,6, and partially aromatic polyamide, a polyvinyl chloride film, a polyvinylidene chloride film, and a polycarbonate film.

A thickness of the film is usually 5 to 200 μm, preferably around 10 to 100 μm. The bonding surface of the pressure-sensitive adhesive layer to the film may be subjected to releasing, anti-staining or acid treatment with silicone, fluorine, long chain alkyl-based or fatty acid amide-based releasing agent, or a silica powder.

The plastic substrate may be subjected to releasing, or anti-staining treatment with silicone, fluorine, long chain alkyl-based or fatty acid amide-based releasing agent, or a silica powder, easy adhesion treatment such as acid treatment, alkali treatment, primer treatment, corona treatment, plasma treatment, and ultraviolet ray treatment, or coating-type, kneading-type, or deposition-type antistatic treatment, if necessary.

The surface of the substrate (support film) may also be subjected to a corona treatment or any other treatment for improving adhesion between the pressure-sensitive adhesive layer and the substrate (support film). The back surface of the substrate (support film) may also be subjected to any treatment.

The substrate (plastic substrate) used in the invention preferably has undergone an antistatic treatment. Such an antistatic treatment may be performed on a plastic substrate using, as a non-limiting example, a method of providing an antistatic layer on at least one side of a general-use backing or a method of kneading a kneading-type antistatic agent into a plastic substrate. Examples of the method of providing an antistatic layer on at least one side of the backing include a method of applying an antistatic resin composed of the antistatic agent described below and a resin component or applying a conductive polymer or a conductive material-containing conductive resin; and a method of vapor-depositing or plating a conductive material.

If necessary, in the pressure-sensitive adhesive film of the present invention, a separator can be bonded onto a surface of a pressure-sensitive adhesive layer for the purpose of protecting a pressure-sensitive adhesive surface. The material used to form the separator may be paper or a plastic film. The plastic film is preferably used because of its good surface smoothness. Such a film may be of any type capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, an ethylene-vinyl acetate copolymer film and the like.

The separator (plastic substrate) used in the invention may also have undergone an antistatic treatment. Such an antistatic treatment may be performed on a plastic substrate using, as a non-limiting example, the same method as described above for the substrate.

Examples of the antistatic agent in the antistatic resin used to form the substrate or the separator include cationic antistatic agents such as quaternary ammonium salts, pyridinium salts, and those having a cationic functional group such as a primary, secondary, or tertiary amino group; anionic antistatic agents such as sulfonates, sulfuric ester salts, phosphonates, phosphoric ester salts, and those having an anionic functional group; amphoteric antistatic agents such as alkyl betaine and derivatives thereof, imidazoline and derivatives thereof, and alanine and derivatives thereof; nonionic antistatic agents such as aminoalcohol and derivatives thereof, glycerin and derivatives thereof, and polyethylene glycol and derivatives thereof; and ion-conducting polymers obtained by polymerization or copolymerization of the cationic anionic and/or amphoteric monomer having an ion-conducting group. These compounds may be used alone or in combination of two or more.

Specifically, examples of the cation-type electrification preventing agent include a (meth)acrylate copolymer having a quaternary ammonium group such as an alkyl trimethylammonium salt, acyloylamidopropyltrimethylammonium methosulfate, an alkylbenzylmethylammonium salt, acyl choline chloride, and polydimethylaminoethyl methacrylate, a styrene copolymer having a quaternary ammonium group such as polyvinylbenzyltrimethylammonium chloride, and a diallylamine copolymer having a quaternary ammonium group such as polydiallyldimethylammonium chloride. The compounds may be used alone, or two or more kinds may be used by mixing.

Examples of the anion-type electrification preventing agent include an alkyl sulfonic acid salt, an alkylbenzenesulfonic acid salt, an alkyl sulfate ester salt, an alkyl ethoxy sulfate ester salt, an alkyl phosphate ester salt, and a sulfonic acid group-containing styrene copolymer. These compounds may be used alone, or two or more kinds may be used by mixing.

Examples of the amphoteric-type electrification preventing agent include alkylbetain, alkylimidazoliumbetain, and carbobetaingrafted copolymer. These compounds may be used alone, or two or more kinds may be used by mixing.

Examples of the nonion-type electrification preventing agent include fatty acid alkylolamide, di(2-hydroxyethyl)alkylamine, polyoxyethylenealkylamine, fatty acid glycerin ester, polyoxyethylene glycol fatty acid ester, sorbitan fatty acid ester, polyoxyethylene sorbitan fatty acid ester, polyoxyethylene alkyl phenyl ether, polyoxyethylene alkyl ether, polyethylene glycol, polyoxyethylenediamine, a copolymer consisting of polyether, polyester and polyamide, and methoxypolyethyleneglycol (meth)acrylate. These compounds may be used alone, or two or more kinds may be used by mixing.

Examples of the electrically conductive polymer include polyaniline, polypyrrole and polythiophene. These electrically conductive polymers may be used alone, or two or more kinds may be used by mixing.

Examples of the electrically conductive substance include tin oxide, antimony oxide, indium oxide, cadmium oxide, titanium oxide, zinc oxide, indium, tin, antimony, gold, silver, copper, aluminum, nickel, chromium, titanium, iron, covert, copper iodide, and an alloy and a mixture thereof.

As a resin component used in the electrification preventing resin and the electrically conductive resin, a generally used resin such as polyester, acryl, polyvinyl, urethane, melanine and epoxy is used. In the case of a polymer-type electrification preventing agent, it is not necessary that a resin component is contained. In addition, the electrification preventing resin component may contain compounds of a methylolated or alkylolated melanine series, a urea series, a glyoxal series, and an acrylamide series, an epoxy compound, or an isocyanate compound as a crosslinking agent.

An electrification preventing layer is formed, for example, by diluting the aforementioned electrification preventing resin, electrically conductive polymer or electrically conductive resin with a solvent such as an organic solvent and water, and coating this coating solution on a plastic substrate, followed by drying.

Examples of an organic solvent used in formation of the electrification preventing layer include methyl ethyl ketone, acetone, ethyl acetate, tetrahydrofuran, dioxane, cyclohexanone, n-hexane, toluene, xylene, methanol, ethanol, n-propanol and isopropanol. These solvents may be used alone, or two or more kinds may be used by mixing.

As a coating method in formation of the electrification preventing layer, the known coating method is appropriately used, and examples include roll coating, gravure coating, reverse coating, roll brushing, spray coating, and air knife coating methods, an immersing and curtain coating method.

A thickness of the aforementioned electrification preventing resin layer, electrically conductive polymer or electrically conductive resin is usually 0.01 to 5 μm, preferably around 0.03 to 1 μm.

Examples of a method of depositing or plating an electrically conductive substance include vacuum deposition, sputtering, ion plating, chemical deposition, spray pyrolysis, chemical plating, and electric plating methods.

The thickness of the electrically-conductive substance layer is generally from 20 to 10000 angstrom (2 to 1000 nm), preferably from 50 to 5000 angstrom (5 to 500 nm).

As the kneading-type antistatic agent, the aforementioned antistatic agent is appropriately used. The amount of the kneading-type antistatic agent to be blended is 20% by weight or less, preferably in a range of 0.05 to 10% by weight, based on the total weight of a plastic substrate. A kneading method is not particularly limited as far as it is a method by which the antistatic agent can be uniformly mixed into a resin used in a plastic substrate, but for example, a heating roll, a Banbury mixer, a pressure kneader, and a biaxial kneading machine are used.

The pressure-sensitive adhesive film of the invention is used for plastic products and other products which can easily generate static electricity. In particular, the pressure-sensitive adhesive film of the invention can be used as a surface protective film to protect the surface of an optical member such as a polarizing plate, a wavelength plate, a retardation plate, an optical compensation film, a reflective sheet, a brightness enhancement film, or a diffusion sheet, which is for use in a display device such as a liquid crystal display or an organic EL display, a touch panel produced with such a display device, and other devices.

### EXAMPLES

Hereinafter, the features and effects of the invention will be more specifically described with reference to examples and others, which however are not intended to limit the invention. The evaluation items in the examples and others were measured as described below.

<Measurement of the Weight Average Molecular Weight of Acryl-Based Polymer>

The weight average molecular weight of the prepared polymer was measured using gel permeation chromatography (GPC).

Analyzer: HLC-8220GPC manufactured by TOSOH CORPORATION Columns:
Columns for sample: TSKguardcolumn Super HZ-H (a single column)+TSKgel Super HZM-H (two columns) manufactured by TOSOH CORPORATION
Reference column: TSKgel Super H-RC (a single column) manufactured by TOSOH CORPORATION
Flow rate: 0.6 ml/minute
Injection volume: 10 μl
Column temperature: 40° C.

### Eluent: THF

Injected sample concentration: 0.2% by weight
Detector: differential refractometer

The weight average molecular weight was the polystyrene-equivalent weight average molecular weight determined using polystyrene calibration.

### <Measurement of Glass Transition Temperature(Tg)>

A glass transition temperature Tg (° C.) was determined by the following equation using the following reference values as a glass transition temperature Tgn (° C.) of a homopolymer of each monomer.

1/(Tg+273)=Σ[Wn/(Tgn+273)] Equation:

[where Tg (° C.) represents a glass transition temperature of a copolymer, Wn (−) represents a weight fraction of each monomer, Tgn (° C.) represents a glass transition temperature of a homopolymer of each monomer, and n represents a kind of each monomer]

### Reference Values:

2-ethylhexyl acrylate: −70° C.
2-hydroxyethyl acrylate: −15° C.
butyl acrylate: −55° C.
acrylic acid: −15° C.

For the literature values, reference was made to “Acryl Jushi no Gosei Sekkei to Shin-Yoto Kaihatsu (Synthesis/Design of Acrylic Resins and Development of New Applications” (published by Chuo Keiei Kaihatsu Center Shuppan-bu)

### <Measurement of Acid Value>

An acid value was measured using an automatically titrating apparatus (COM-550 manufactured by HIRANUMA SANGYO Co., Ltd.), and was obtained by the following equation.

A={(Y−X)×f×5.61}/M

A; Acid value

Y; Titration amount of sample solution (ml)

X; Titration amount of solution of only 50 g of mixed solvent (ml)

f; Factor of titration solution

M; Weight of polymer sample (g)

Measuring conditions are as follows.

Measurement conditions are as follows:

Sample solution: About 0.5 g of a polymer sample was dissolved in 50 g of a mixed solvent (toluene/2-propanol/distilled water=50/49.5/0.5, weight ratio) to obtain a sample solution.

Titration solution: 0.1N 2-propanolic potassium hydroxide solution (for petroleum product neutralization value test manufactured by Wako Pure Chemical Industries, Ltd.)

Electrode: glass electrode; GE-101, comparative electrode; RE-201, Measurement mode: petroleum product neutralization value test 1

<Measurement of Peeling Electrification Voltage>

The pressure-sensitive adhesive film (surface protective film) was cut into a piece with a size of 70 mm in width and 130 mm in length, and the separator was peeled off. Using a hand roller, the piece was then pressure-bonded to the surface of a 1 mm thick, 70 mm wide, 100 mm long acrylic panel (ACRYLITE manufactured by Mitsubishi Rayon Co., Ltd.), which had undergone static elimination in advance, in such a way that one end of the piece protruded 30 mm out of the panel. The resulting sample was allowed to stand in an environment at 23° C. and 50% RH for a day and then set at a predetermined location. The one end protruding 30 mm was fixed to an automatic winder, and the piece was peeled off at a peeling angle of 150° and a peeling rate of 10 m/minute. The removed adhesive film (surface protective film) was placed on a sample mount, and the potential on the surface of the pressure-sensitive adhesive was measured using an electrostatic voltmeter (KSD-0103 manufactured by KASUGA ELECTRIC WORKS LTD.) fixed at a predetermined position. The measurement was performed in an environment at 23° C. and 50% RH.

The pressure-sensitive adhesive film of the invention preferably has an absolute value of peeling electrification voltage of 0.5 kV or less, more preferably 0.4 kV or less, even more preferably 0.3 kV or less, as measured under the conditions of 23° C. and 50% RH after it is peeled off from an adherend of an acrylic panel at a peeling rate of 10 m/minute. Within the range, the pressure-sensitive adhesive film has good antistatic properties.

<Measurement of Adhesive Strength>

The pressure-sensitive adhesive film (surface protective film) was cut into a piece with a size of 25 mm in width and 100 mm in length, and the cut piece was laminated to an acrylic panel (ACRYLITE manufactured by Mitsubishi Rayon Co., Ltd.) under the pressure bonding conditions of 0.25 MPa and a rate of 0.3 m/minute, so that an evaluation sample was obtained. After the lamination, the sample was allowed to stand for 30 minutes and then measured for adhesive strength with a universal tensile tester while the piece was peeled off at a peeling angle of 180° and a tension (peeling) rate of 1.0 m/minute. The measurement was performed in an environment at 23° C. and 50% RH.

The pressure-sensitive adhesive film of the invention has an adhesive strength of 0.5 N/25 mm or more (high adhesive strength), preferably 0.6 to 6 N/25 mm, more preferably 0.6 to 4 N/25 mm, as measured at a tension rate of 1.0 m/minute after it is placed on an adherend of an acrylic panel under the conditions of 23° C. and 50% RH for 30 minutes. Within the range, the pressure-sensitive adhesive film can exhibit sufficient adhesive properties even to an adherend having unevenness on its surface (having a non-smooth surface), such as a diffusion sheet.

<Preparation Of (Meth)Acryl-Based Polymer>

[Acryl-Based Polymer (A)]

A four-neck flask equipped with a stirring blade, a thermometer, a nitrogen gas introducing tube, and a condenser was charged with 200 parts by weight of 2-ethylhexyl acrylate, 8 parts by weight of 2-hydroxyethyl acrylate, 0.4 parts by weight of 2,2′-azobisisobutyronitrile as a polymerization initiator, and 312 parts by weight of ethyl acetate. Nitrogen gas was introduced into the flask while the mixture was gently stirred, and a polymerization reaction was performed for about 6 hours while the temperature of the liquid in the flask was kept at about 65° C., so that a solution (40% by weight) of an acryl-based polymer (A) was obtained. The acryl-based polymer (A) had a weight average molecular weight of 500,000, a glass transition temperature (Tg) of −68° C. and an acid value of 0.0.

<Preparation of Ionic Liquid>

A 20% by weight aqueous solution of 10 parts by weight of 1-butyl-3-methylpyridinium chloride (manufactured by Wako Pure Chemical Industries, Ltd.) was added to a four-neck flask equipped with a stirring blade, a thermometer, and a condenser. A 20% by weight aqueous solution of 19 parts by weight of lithium bis(trifluoromethanesulfonyl)imide (manufactured by KISHIDA CHEMICAL Co., Ltd.) was then gradually added to the flask while the stirring blade was rotated. After the addition, the mixture was continuously stirred at room temperature (23° C.) for 2 hours and then allowed to stand for 12 hours. The supernatant liquid was removed, and a liquid product was obtained. The resulting liquid product was washed three times with 100 parts by weight of distilled water, and then subjected to drying at a temperature of 110° C. for 2 hours, so that 20 parts by weight of an ionic liquid was obtained, which was liquid at room temperature. The resulting ionic liquid was identified as 1-butyl-3-methylpyridinium bis(trifluoromethanesulfonyl)imide using NMR, FT-IR, and XRF analysis.

<Preparation of Antistatic-Treated Film>

An antistatic agent solution was prepared by diluting 10 parts by weight of an antistatic agent (MICRO-SOLVER RMd-142 manufactured by SOLVEX INC. (composed mainly of tin oxide and polyester resin)) with a mixed solvent of 30 parts by weight of water and 70 parts by weight of methanol.

The resulting antistatic agent solution was applied to a polyethylene terephthalate (PET) film (38 μm in thickness, substrate) using a Mayer bar. The solvent was removed by drying at 130° C. for 1 minute. As a result, an antistatic layer (0.2 μm in thickness) was formed, and an antistatic-treated film was obtained.

### Example 1

[Preparation of Pressure-Sensitive Adhesive Solution]

To 100 parts by weight (solid basis) of the acryl-based polymer (A) were added 0.2 parts by weight of the ionic liquid, 0.5 parts by weight (solid basis) of a trimethylolpropane-tolylene diisocyanate trimer adduct (CORONATE L manufactured by Nippon Polyurethane Industry Co., Ltd.) as a crosslinking agent, and 0.02 parts by weight of dibutyltin dilaurate as a crosslinking catalyst. The mixture was stirred and mixed for about 1 minute while kept at about 25° C. and then diluted to 20% by weight with ethyl acetate, so that an acryl-based pressure-sensitive adhesive solution (1) was obtained.

[Preparation of Pressure-Sensitive Adhesive Film]

The acryl-based pressure-sensitive adhesive solution (1) was applied to the surface of the antistatic-treated film opposite to its antistatic-treated surface, and heated at 110° C. for 3 minutes to form a 20 μm thick pressure-sensitive adhesive layer. Subsequently, a polyethylene terephthalate (PET) film (25 μm in thickness) with its one side silicone-treated was provided, and the surface of the pressure-sensitive adhesive layer was bonded to the silicone-treated side of the polyethylene terephthalate film, so that a pressure-sensitive adhesive film was obtained. The silicone-treated PET film was peeled off when the pressure-sensitive adhesive film was used.

### Example 2

A pressure-sensitive adhesive film was prepared using the same process as in Example 1, except that the ionic liquid was added in an amount of 0.4 parts by weight when the pressure-sensitive adhesive was prepared.

### Example 3

A pressure-sensitive adhesive film was prepared using the same process as in Example 1, except that the ionic liquid was added in an amount of 0.6 parts by weight when the pressure-sensitive adhesive was prepared.

### Example 4

A pressure-sensitive adhesive film was prepared using the same process as in Example 1, except that the ionic liquid was added in an amount of 1.0 part by weight when the pressure-sensitive adhesive was prepared.

### Example 5

A pressure-sensitive adhesive film was prepared using the same process as in Example 1, except that the ionic liquid was added in an amount of 2.0 parts by weight when the pressure-sensitive adhesive was prepared.

### Example 6

A pressure-sensitive adhesive film was prepared using the same process as in Example 1, except that the crosslinking agent was added in an amount of 2.0 parts by weight (solid basis, hereinafter the same applies) when the pressure-sensitive adhesive was prepared.

### Comparative Example 1

A pressure-sensitive adhesive film was prepared using the same process as in Example 1, except that the ionic liquid was not added when the pressure-sensitive adhesive was prepared.

### Comparative Example 2

A pressure-sensitive adhesive film was prepared using the same process as in Example 1, except that the ionic liquid was added in an amount of 3.0 parts by weight when the pressure-sensitive adhesive was prepared.

### Comparative Example 3

A pressure-sensitive adhesive film was prepared using the same process as in Example 1, except that the crosslinking agent and the ionic liquid were added in amounts of 4.0 parts by weight and 0.6 parts by weight, respectively, when the pressure-sensitive adhesive was prepared.

The prepared pressure-sensitive adhesive films were evaluated for adhesive strength and peeling electrification voltage according to the methods described above. Table 1 shows the results.

TABLE 1

| | | | | | | | | Comparative | | |
|---|---|---|---|---|---|---|---|---|---|---|
| Formulation and | | Example | | | | | | Example | | |
| evaluation results | Units | 1 | 2 | 3 | 4 | 5 | 6 | 1 | 2 | 3 |
| Ionic liquid | Parts by | 0.2 | 0.4 | 0.6 | 1.0 | 2.0 | 0.2 | — | 3.0 | 0.6 |
| | weight | | | | | | | | | |
| Crosslinking | Parts by | 0.5 | 0.5 | 0.5 | 0.5 | 0.5 | 2.0 | 0.5 | 0.5 | 4.0 |
| agent | weight | | | | | | | | | |
| Adhesive strength | N/25 mm | 2.4 | 2.2 | 2.0 | 1.7 | 0.8 | 0.6 | 3.5 | 0.3 | 0.3 |
| Peeling | KV | 0.0 | 0.0 | 0.0 | 0.0 | 0.0 | 0.0 | 3.3 | 0.0 | 0.0 |
| electrification | | | | | | | | | | |
| voltage (absolute | | | | | | | | | | |
| value) | | | | | | | | | | |

From the results in Table 1, it is apparent that the pressure-sensitive adhesive film of each of Examples 1 to 6, which has the pressure-sensitive adhesive layer according the invention, exhibits good adhesive properties, specifically, sufficient adhesive properties even to an adherend having unevenness on its surface (having a non-smooth surface), is prevented from generating a peeling electrification voltage, and has good antistatic properties. In contrast, it is apparent that in each of Comparative Examples 1 to 3, adhesive properties and antistatic properties cannot be simultaneously satisfied at satisfactory levels.

1. A pressure-sensitive adhesive film, comprising a substrate and a pressure-sensitive adhesive layer provided on at least one side of the substrate, wherein
the pressure-sensitive adhesive layer contains a (meth)acryl-based polymer, an ionic liquid, and a crosslinking agent, and
the pressure-sensitive adhesive layer contains 2 parts by weight or less of the crosslinking agent based on 100 parts by weight of the (meth)acryl-based polymer,
the pressure-sensitive adhesive film having an adhesive strength of 0.5 N/25 mm or more as measured at a tension rate of 1.0 m/minute after it is placed on an adherend of an acrylic panel under conditions of 23° C. and 50% RH for 30 minutes.

2. The pressure-sensitive adhesive film according to claim 1, which has an absolute value of peeling electrification voltage of 0.5 kV or less as measured under conditions of 23° C. and 50% RH after it is peeled off from an adherend of an acrylic panel at a peeling rate of 10 m/minute.

3. The pressure-sensitive adhesive film according to claim 1, wherein the (meth)acryl-based polymer has a (meth)acryl-based monomer having an alkyl group of 1 to 14 carbon atoms.

4. The pressure-sensitive adhesive film according to claim 1, wherein the ionic liquid is contained in an amount of 0.01 to 2.5 parts by weight based on 100 parts by weight of the (meth)acryl-based polymer.

5. The pressure-sensitive adhesive film according to claim 1, which is for use in protecting a surface of a diffusion sheet.

6. The pressure-sensitive adhesive film according to claim 2, which is for use in protecting a surface of a diffusion sheet.

7. The pressure-sensitive adhesive film according to claim 3, which is for use in protecting a surface of a diffusion sheet.

8. The pressure-sensitive adhesive film according to claim 4, which is for use in protecting a surface of a diffusion sheet.
